(19) United States
(12) Patent Application Publication
(10) Pub. No.: US 2003/0163448 A1
(43) Pub. Date: Aug. 28, 2003

(54) Scripting service for translating browser requests into command line interface (CLI) commands

(75) Inventors: Shadrack K. Kilemba, Nashua, NH (US); Paul M. Hendley, Lancaster, MA (US); Andres M. Perez, Waltham, MA (US)

Correspondence Address: LAHIVE & COCKFIELD, 28 STATE STREET, BOSTON, MA, 02109, US

(73) Assignee: Sun Microsystems, Inc., Palo Alto, CA

(21) Appl. No.: 10/085,796

(22) Filed: Feb. 26, 2002

(51) Int. Cl. G06F 7/00

(52) U.S. Cl. 707/1

(57) ABSTRACT

A scripting service receives requests from a browser client that includes an executing web browser. The request is then translated into a command line interface (CLI) command. The CLI command may be displayed for a user to understand how browser requests are translated into corresponding CLI commands. In addition, a translated command may be stored in a script of other translated commands. The script may be stored persistently for subsequent use. The script may also be passed to a CLI client for execution. The scripting service is especially well adapted for use with web based application such as a management application that manages items in a distributed environment.

### RELATED APPLICATIONS

This application is related to co-pending application, entitled “Registration Service for Registering Plug-in Applications with a Management Console,” application Ser. No. ______ (Attorney Docket No. SMQ-083), and co-pending application entitled, “Command Line Interface (CLI) Session Tool,” application Ser. No. ______ (Attorney Docket No. SMQ-085), which were filed on even date herewith, assigned to a common assignee with the present application and explicitly incorporated by reference herein.

### TECHNICAL FIELD OF THE INVENTION

The present invention relates generally to data processing systems and more particularly to a scripting service for translating browser requests into command line interface (CLI) commands.

### BACKGROUND

CLIs provide an efficient interface for users to perform tasks but are often difficult to use. In order to effectively use a CLI, a user must be familiar with what commands are available for use with the CLI. In addition, the user must know the syntax of the command, including what options are available with the command.

Graphical user interfaces (GUIs) have become increasingly popular because they are easier to use than CLIs. A well-designed GUI enables a use to intuitively determine how to perform various tasks. Unfortunately, some GUIs may not be as powerful as the CLIs. In addition, some GUIs may require a rather cumbersome chain of actions to perform an activity that can be more efficiently invoked via a single CLI command.

### SUMMARY

Embodiments of the present invention address the difficulties found with such user interfaces by providing the user with a scripting service that translates browser requests into CLI commands. The translated CLI commands may be displayed to the user to help the user understand the relationship between browser requests and CLI commands. The translated commands may be persistently stored and organized into a script. Such scripts may be subsequently executed by a CLI client. This allows repetitious tasks to be performed once, captured in a script and then executed as needed.

In accordance with one aspect of the present invention, a management application is run on an electronic device that is interfaced with the network. The management application is responsible for managing items. A request is received by the management application from a web browser client (i.e., from a device that is running a web browser). The request is translated into one or more CLI commands. The CLI commands may be stored for later use and may be displayed on a display device for the user to view.

In accordance with a further aspect of the present invention, the requests are received at a web server from a client using a web browser. The requests are translated into CLI commands and recorded in a script. The script is forwarded to the client for display on a display device.

In accordance with an additional aspect of the present invention, an electronic device includes a network interface for interfacing with the network. The electronic device also includes a management application for servicing requests from clients received from the network via the network interface. The electronic device additionally includes a scripting service for receiving the requests from the clients and translating the requests into CLI commands.

### BRIEF DESCRIPTION OF THE DRAWINGS

An illustrative embodiment of the present invention will be described below relative to the following drawings.

FIG. 1 depicts a distributed environment that is suitable for practicing the illustrative embodiment of the present invention.

FIG. 2 depicts components that are employed in translating a request into one or more CLI commands in the illustrative embodiment.

FIG. 3 is a flow chart providing an overview of the steps that are performed in processing a request originating from a web browser client.

FIG. 4 is a flow chart illustrating the steps that are performed to translate a request originating from a web browser client into a CLI command.

FIG. 5 illustrates the hierarchy of a portion of a registration descriptor that identifies a CLI command supported by an application.

FIG. 6 is a flow chart illustrating the steps that are performed to execute a script by the illustrative embodiment of the present invention.

### DETAILED DESCRIPTION

The illustrative embodiment provides a scripting service for translating browser requests originating from a web browser client into CLI commands. The CLI commands may be displayed on a display device so that a user understands the mapping between activity with a web browser and corresponding CLI commands. In addition, the translated commands may be stored in a script in persistent storage. Subsequently, the script may be passed to a CLI client to execute the script.

The illustrative embodiment is designed for use with web-based applications where a client communicates with a server over a network. The illustrative embodiment will be described with respect to a web-based management application that is responsible for managing items in a storage area network. Nevertheless, those skilled in the art will appreciate that the present invention is not limited to such an environment where a management application manages a storage area network. Instead, the present invention may be practiced with other varieties of applications where the scripting service would be useful.

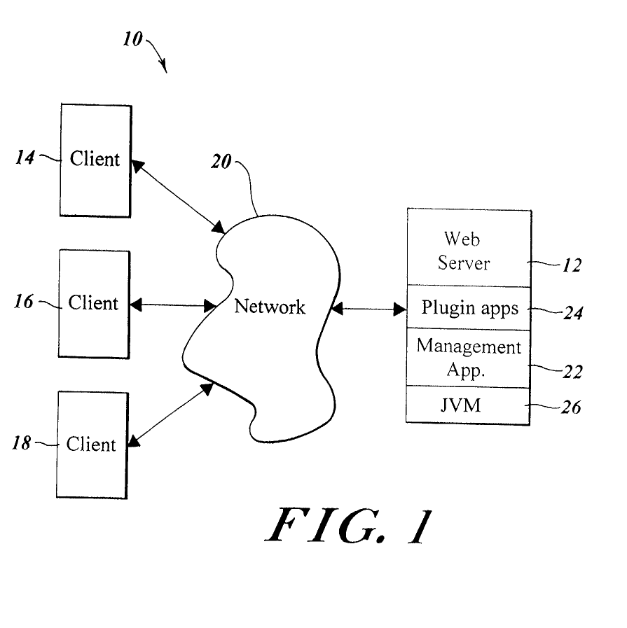

FIG. 1 depicts a distributed environment 10 that is suitable for practicing the illustrative embodiment to the present invention. In this environment 10, a web server 12 is interfaced with a network 20. Clients 14, 16, and 18 are also interfaced with the network 20 and communicate with the web server 12 over the network. The web server 12 includes a management application 22 for managing items. For illustrative purposes, it is presumed that the management application 22 is responsible for managing components within the storage area network (SAN). Plug-in applications 24 may register to embellish or enhance the functionality provided by the management applications 22. The registration service is described in co-pending application entitled, “Registration Service for Registering Plug-in Applications with a Management Application.” The plug-in applications 24 register with the management application 22 and then may be used in conjunction with the management application. In the illustrative embodiment, it is presumed that the management application and plug-in applications are written in the JAVA programming language and thus, there is a JAVA virtual machine (JVM) 26 on the web server 12.

Those skilled in the art will appreciate that the configuration depicted in FIG. 1 is intended to be merely illustrative and not limiting of the present invention. The server 12 need not be a web server; rather it may be another variety of server or peer. The network 20 may take many forms including that of a package switch network, such as the Internet, and intranet or extranet, or another variety of network including but not limited to a wireless network, local area network, or the like. The clients 14, 16 and 18 may run on a variety of different machines including but not limited to personal computers, workstations, Internet appliances, personal digital assistants, intelligent pagers, cellular phones, electronic books, or the like. In addition, there may be a greater number of clients that interface with the server 12 as depicted in FIG. 1. In some cases, however, there may be fewer than three clients. Still further, the applications need not be written in the JAVA programming language, but rather may be written in other programming language, including scripting language and high level languages.

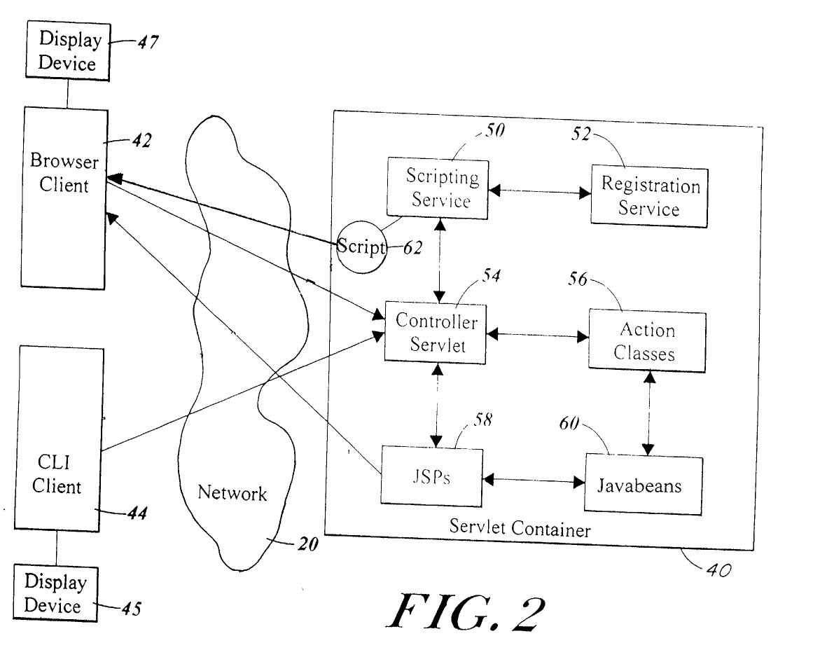

FIG. 2 depicts the interaction between clients and the management application 22 of the illustrative embodiment. Two varieties of clients are depicted in FIG. 2: a browser client 42 and a CLI client 44. The browser client 42 has a web browser, such as Microsoft Internet Explorer, Netscape Navigator, or a JAVA web browser from Sun Microsystems, Inc. running on the client machine. The web browser has a GUI that a user may use to interact with a web server 12 and the management application 22. It is presumed that the browser client 42 can communicate over the network 20 by issuing hypertext transfer protocol (HTTP) requests. HTTP is a response/request protocol where a server provides responses in response to requests from clients.

The second variety of client is a CLI client 44. The CLI client 44 provides the user with a CLI. The user types commands on the command line to interact with the web server 12. It is presumed that these commands are packaged into HTTP requests that are forwarded to the web server 12. Those skilled in the art will appreciate that the present invention does not require that HTTP be utilized, but rather HTTP is discussed as an exemplary protocol that works with packaged switched networks such as the Internet.

The management application 22 is implemented in the illustrative embodiment as a servlet. The servlet container 40 is an object that contains a number of additional components. These additional components include a scripting service 50 that is responsible for translating of requests originating from the browser client 42 into CLI commands. As will be described in more detail below, the resulting translated commands may be organized into a script 62 that may be stored persistently. The servlet container 40 also includes a controller servlet 54 that acts as an interface with the clients 42 and 44. The controller servlet 54 acts as a sort of “traffic cop” for determining where a request should be forwarded for appropriate handling. A number of JAVA server pages (JSPs) 58 may be provided for generating appropriate web page responses that are forwarded to the browser client 42 in response to requests. JSPs include executable code that may generate dynamic web content. The servlet container 40 may also include a number of JavaBeans 60. JavaBeans are reusable components that conform to a model specified by Sun Microsystems, Inc. The JavaBeans 60 provide componentized units of functionality that help to respond to client requests.

The servlet container 40 may also include action classes 56. An action class is a variety of action that is associated with a given type of HTTP request. Sun Microsystems, Inc. has defined a number of packages that define functionality for supporting HTTP. These packages include support for request dispatchers that dispatch HTTP requests to destinations and HTTP handlers that receive the request and generate the appropriate response. For each variety of HTTP response, there is an associated action having a given action class that defines what entity should handle the HTTP request. The appropriate entity is then called to respond to the request. The entity may be a servlet, a JavaBeans component, a JSP or combination thereof.

The servlet container 40 additionally includes a registration service 52. The registration service is responsible for registering plug-in applications with the management application. Plug-in applications provide a registration descriptor in the form of an extensible mark-up language (XML) file. The registration service parses the XML file to complete the registration. The XML file contains information regarding the functionality provided by the plug-in applications. This information includes what CLI commands are supported by the application. The portion of the registration descriptor XML file that relates to the CLI commands will be discussed in more detail below. The interaction among the components will be described in more detail below when the particulars of operation of the management application scripting service are set forth.

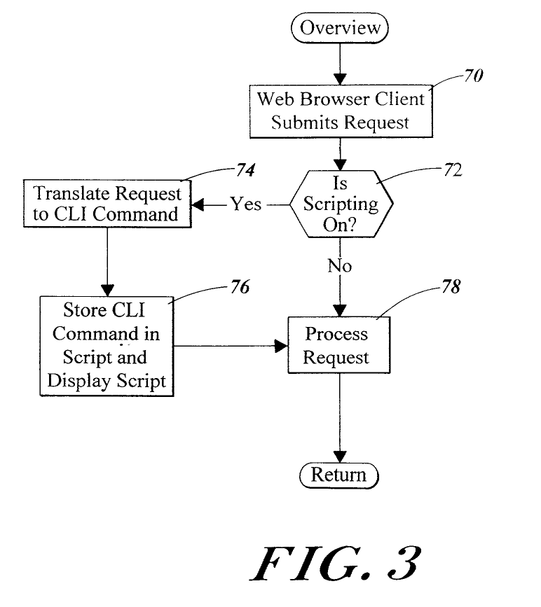

FIG. 3 provides an overview of the steps that are performed in the illustrative embodiment of the present invention. Initially, a web browser client 42 submits a request to the management application 22 (step 70 in FIG. 3). For example, a client user may request a given action by selecting a menu item. This is translated by the web browser, into an HTTP request that is sent to the management application 22. The resulting request is received by the controller servlet 54. The scripting may be set either “on” or “off” by a user. If the scripting is set “off,” (see step 72 in FIG. 3) there is not translation of the web browser client request into a CLI command. Thus, the request is processed as it normally would be processed (step 78 in FIG. 3). Specifically, the controller servlet 54 passes the request to the appropriate action class 56, which may create, or invoke JavaBeans 60 and may cause the JSP 58 to generate a response to the browser client 42. In contrast, if the scripting is “on” (see step 72 in FIG. 3), the scripting service 50 translates the request into a CLI command (step 74 in FIG. 3). The CLI command may then be stored persistently, either locally at web server 12, or remotely back with the client. In addition, the CLI command may be displayed on the display device such as the display devices 45 or 47 that are shown in FIG. 2 (step 76 in FIG. 3). The result 62 may be sent to the browser client 42 for display or may be stored in persistent storage. The original request is processed by the scripting service 50 returning the request to the controller servlet 54 for processing (step 78 in FIG. 3).

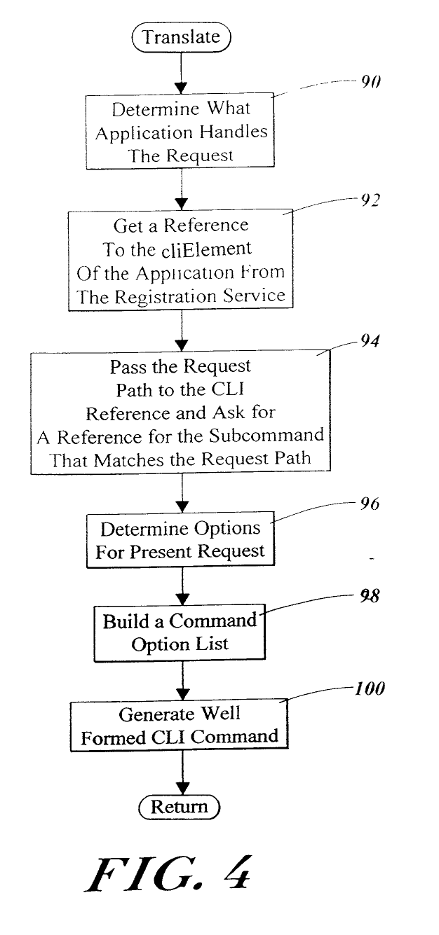

FIG. 4 sets forth in more detail the steps performed by the scripting service 50 in translating the web browser client request into a CLI command. Initially, the scripting service 50 must determine what application handles the variety of requests that have been received (step 90 in FIG. 4). In that regard, the scripting service 50 may consult with the registration service 52 to determine what application handles the variety of request. In particular, the registration descriptors of plug-in applications provide information regarding what application handles the variety of request. Hence, the registration service 52 needs to look up the application in information that is extracted from the registration descriptors. The request may be handled directly by the management application 22 or by the plug-in applications 24. The scripting service 50 gets a reference to the CLI element of the application that handles the request from the registration service 52 (step 92 in FIG. 4). The CLI element is associated with a given CLI application. In order to better appreciate the role of the CLI element, it is helpful to review the organization of the registration descriptor for an application. As was mentioned above, the registration descriptor is organized as an XML file.

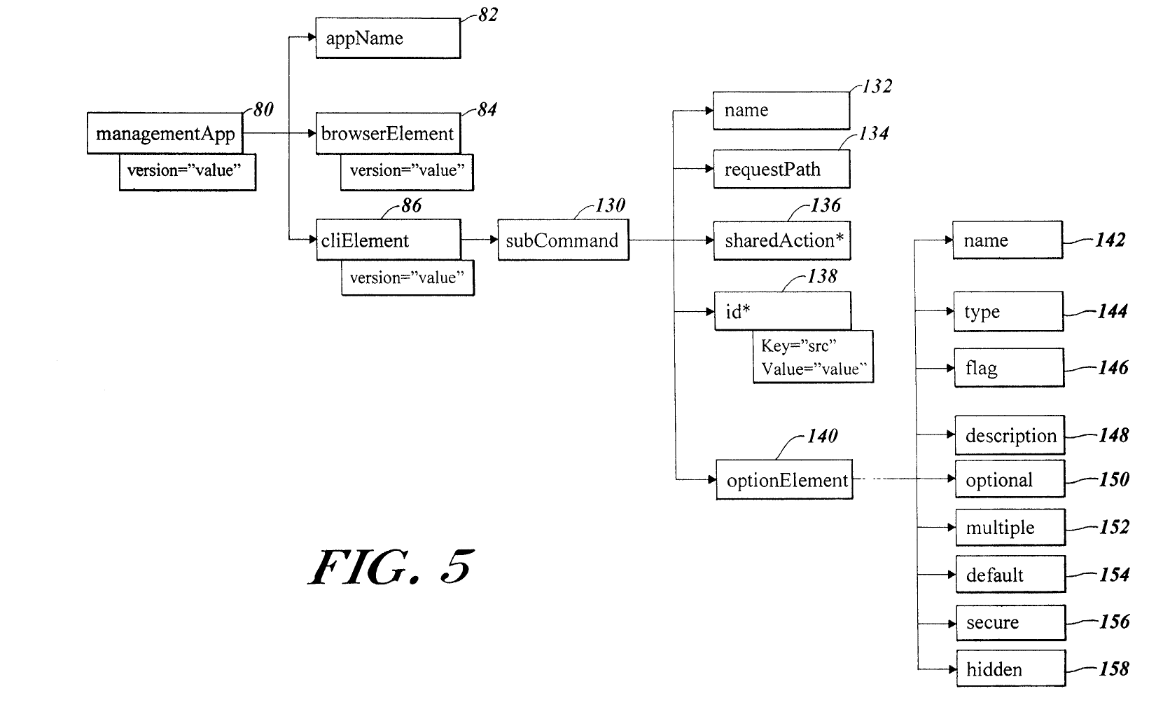

FIG. 5 depicts a portion of the hierarchical organization of the XML file that is pertinent to the illustrative embodiment. The registration descriptor file includes a number of hierarchically organized tags. These tags include a root tag 80 that is associated with the application. The AppName tag 82 holds information regarding the name of the plug-in application. The browserElement tag 84 holds information regarding browser requests that are serviced by the application. The CLI element tag 86 holds information regarding a CLI command that is supported by the application. Each command has a subcommand tag 130. The subcommand tag 130 includes a nametag 132 that specifies the name of the command and a requestPath tag 134 that specifies the requestPath of the command. HTTP requests may include a requestPath that identifies the resource upon which to apply the request.

The sharedAction tag 136 is for instances where two different browser requests are so similar that they can be handled by the same action class. The presence of this tag indicates such case.

The id tag 138 contains a key attribute and a value attribute. These attributes are further used to define a request of uniform resource identifier (URI) so that the action class can call the proper methods. The optionElement tag 140 is provided for each option that may be associated with a given CLI command. The optionElement tag includes a number of additional tags, including the nameTag 142 that holds the name of the option. The type flag 144 identifies whether the option is a string value or a Boolean value. The string type indicates that the option takes a value and the Boolean type indicates the option toggle some functionality on and off. The flag tag 146 identifies the character or characters that are passed to the command to activate the option.

The description tag 148 holds a string that describes the option. The optional tag 150 indicates whether the option is required or whether the option is optional. The multiple tag 152 indicates whether the option takes multiple arguments or a single argument. The default tag 154 holds a default value for the option if any. The sensitive tag 156 indicates whether the value contained in this option is sensitive or not. The hidden tag 158 indicates options a user may not be interested in seeing in a help session.

After the reference of CLI element of the application is obtained from the registration service in step 92 in FIG. 4, the request path from the HTTP request is passed to the CLI reference and a request is made for a reference for the subcommand that matches the request path (see step 94 in FIG. 4). In other words, a request is made to see what subcommand is associated with the request path specified in the HTTP browser request.

The scripting service 50 then determines which of the options are present in the current request (step 96 in FIG. 4) and builds the command option list (step 98 in FIG. 4). The subcommand is combined with the option list to generate a well-formed CLI command (step 100 in FIG. 4).

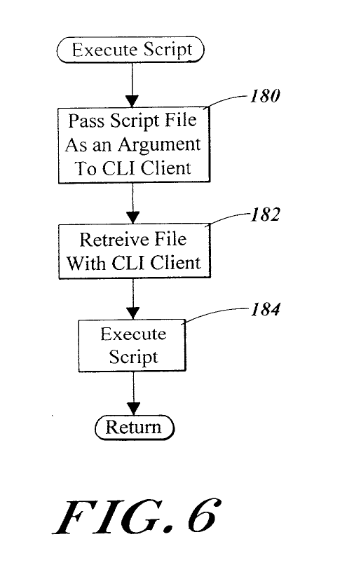

Once the CLI command is formed, it is added to a script that may be stored persistently. Portions of the script may be displayed on the display device, as has been discussed above. In addition, the script may be executed subsequently. FIG. 6 is flow chart that illustrates the steps that are performed to execute the script. The script file is passed as an argument to the CLI client 44 (step 180 in FIG. 6). The file is then retrieved by the CLI client 44 (step 182 in FIG. 6). The CLI client then proceeds to execute the commands in the script in sequence so as to fully execute the script (step 184 in FIG. 6). The CLI session tool that runs at the CLI client 44 is described in more detail in co-pending application, entitled, “Command Line Interface (CLI) Session Tool.”

While the present invention has been described with reference to an illustrative embodiment thereof, those skilled in the art will appreciate that various changes in form and detail may be made without departing from the intended scope of the present invention as defined in the appended claims.

1. In an electronic device interfaced with a network, a method, comprising the steps of:
running a management application on the electronic device for managing items;
receiving a request at the management application from a web browser client; and
translating the request into one or more command line interface (CLI) commands.

2. The method of claim 1 further comprising the step of:
storing the CLI commands that result from the translating.

3. The method of claim 1 further comprising the step of forwarding the CLI commands that result from the translating to a CLI client.

4. The method of claim 1, wherein the electronic device includes a display and wherein the CLI commands that result from the translating are output on the display.

5. The method of claim 1 further comprising the steps of:
receiving additional requests at the management application from the web browser client; and
translating the additional requests into CLI commands.

6. The method of claim 5 further comprising storing the CLI commands resulting from the translating of the additional requests in a script.

7. The method of claim 6 further comprising the step of executing the script.

8. The method of claim 1 further comprising the step of responding to the request independently of the translating.

9. The method of claim 1, wherein the management application has a plug-in application registered with the management application to provide enhanced functionality and wherein the plug-in application provides information to the management application regarding how to translate the request into the one or more CLI commands.

10. The method of claim 1, wherein the management application manages items in a storage area network (SAN).

11. On a web server, a method, comprising the steps of:
receiving requests from a client using a web browser;
translating the requests into command line interface (CLI) commands;
recording the commands in a script; and
forwarding the script to the client for display on a display device.

12. The method of claim 11 further comprising the step of sending responses to the client in response to the requests.

13. The method of claim 11 further comprising the step of:
providing a CLI client that submits requests to the web server from a client machine, said CLI client including a CLI for entering commands;
passing the script to the CLI; and
executing the script.

14. The method of claim 11 further comprising the step of persistently storing the script.

15. An electronic device, comprising:
a network interface for interfacing with a network;
a management application for servicing requests from clients received from the network via the network interface; and
a scripting service for receiving the requests from said clients and translating the requests into command line interface (CLI) commands.

16. The electronic device of claim 15 further comprising a storage for storing the CLI commands.

17. A medium for use in an electronic device that is interfaced with a network, said electronic device running a management application for managing items, said medium holding instructions for performing a method, comprising the steps of:
running a management application on the electronic device for managing items;
receiving a request at the management application from a web browser client; and
translating the request into one or more command line interface (CLI) commands.

18. The medium of claim 18, wherein the method further comprises the step of:
storing the CLI commands that result from the translating.

19. The medium of claim 18, wherein the method further comprises the step of:
of forwarding the CLI commands that result from the translating to a CLI client.

20. The medium of claim 18, wherein the method further comprises the step of:
displaying the CLI commands on a display device.

21. The medium of claim 18, wherein the method further comprises the steps of:
receiving additional requests at the management application from the web browser client; and
translating the additional requests into CLI commands.

22. The medium of claim 18, wherein the method further comprises the steps of
receiving requests from a client using a web browser;
translating the requests into command line interface (CLI) commands;
recording the commands in a script; and
forwarding the script to the client for display on a display device.
